(19) United States
(12) Patent Application Publication
(10) Pub. No.: US 2002/0198013 A1
(43) Pub. Date: Dec. 26, 2002

(54) Cellular handset transceiver system for minimal power consumption

(76) Inventors: Carl M. Panasik, Garland, TX (US); Steve Lazar, Plano, TX (US)

Correspondence Address: TEXAS INSTRUMENTS INCORPORATED, P O BOX 655474, M/S 3999, DALLAS, TX, 75265

(21) Appl. No.: 09/887,778

(22) Filed: Jun. 22, 2001

(51) Int. Cl. H04B 7/00

(52) U.S. Cl. 455/522; 455/69

(57) ABSTRACT

A system and method of wireless data communication between a base station and a mobile station employs mobile receiver and computing algorithms to cause the mobile station transmitter to selectively enter a low power or idle transmission mode when the mobile station is in a shadow of the base station such that wasted RF and DC power is avoided in poor propagation situations. Cellular handset battery power is thus conserved to extend CDMA handset talk time.

### BACKGROUND OF THE INVENTION

1. Field of the Invention

This invention relates generally to cellular handset transceivers and more particularly to a cellular handset transceiver system designed to minimize power consumption in propagation situations that exceed the capability of the base station/mobile station system.

2. Description of the Prior Art

CDMA handset power amplifier output probability distributions (measured and simulated) for cellular systems show a non-Gaussian effect at maximum output power. FIG. 1, for example, is a graph illustrating measured probability output power (Pout) that is fit to a normal distribution at the same Pout points for an IS-95 CDMA handset power amplifier as presented by J. Sevic, The Time Domain and Power Amplifier Linearity and Efficiency, Proc. Advancing the Frontiers of Microwave Radio, MTT Short Course, April 1998. It can be seen that a 6% peak occurs at maximum output power (25 dBm). FIG. 2 is a graph illustrating a simulated distribution function of output power in a WCDMA system that employs a Nokia® handset as presented by H. Lilja, H. Mattila, WCDMA Power Amplifier Requirements and Efficiency Optimization Criteria, IEEE Microwave Theory and Techniques Symposium (MTT-S), THF4-2, 1999. It can be seen that a 50% peak occurs at maximum power out. These power levels are commanded by the base station and are a function of the signal to noise level at the base station receiver. FIGS. 1 and 2 demonstrate that at high power, the curve is not symmetrical and has a distinct peak at the highest output power where the most battery power is consumed.

In view of the foregoing, a need exists for a scheme to limit mobile transmitter output in poor propagation situations to avoid wasted RF and DC power.

### SUMMARY OF THE INVENTION

The present invention is directed to a system and method of improving cellular handset transceiver system handset efficiency and power control. In addition to employing a standard closed loop (base station receive and mobile station transmit) power control algorithm, a knowledge of the mobile station received signal-to-noise ratio (SNR) is used to disable the mobile station transmitter and prevent a fruitless expenditure of battery power. When the mobile station received SNR falls below a set threshold, there is no point in continuing to transmit from the mobile station, as the handset is in a propagation shadow and incapable of communicating with the base station. In one aspect of the present invention, a method of operating a base station/mobile station system extends CDMA handset talk time between about 5% and at least 15%.

According to one embodiment, mobile station receiver and computing algorithms instruct the mobile station transmitter to enter into the idle condition (power) until a useful receive signal is acquired again. At that point, the mobile transmitter is ramped up to its previous power.

According to another embodiment, a mobile station transmitter does not ramp back to its idle mode (i.e. off state), but instead to a median transmit power condition that was employed during a previous period of time, such as that which was sufficient to support the link up to the point of fade.

### BRIEF DESCRIPTION OF THE DRAWINGS

Other aspects, features and advantages of the present invention will be readily appreciated as the invention becomes better understood by reference to the following detailed description when considered in connection with the accompanying drawings in which like reference numerals designate like parts throughout the figures thereof and wherein:

FIG. 1 is a graph illustrating measured probability power out that is fit to a normal distribution at the measured Pout points for an IS-95 CDMA handset power amplifier;

FIG. 2 is graph illustrating a simulated distribution function of output power in a WCDMA system that employs a Nokia® handset power amplifier;

FIG. 3 is a graph illustrating one representation of a base station received signal to noise ratio and a mobile station transmitted power level;

FIG. 4 is a graph illustrating one representation of a mobile station receiver SNR, an original transmit power spectrum associated with the mobile station transmitter and an improved transmit power spectrum associated with the mobile station transmitter;

FIGS. 5-8 are diagrams illustrating cellular handset transceiver systems for minimal power consumption according to different embodiments of the present invention; and

FIG. 9 is a diagram illustrating communication between a base station and a mobile handset via a reflected path.

While the above-identified drawing figures set forth alternative embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

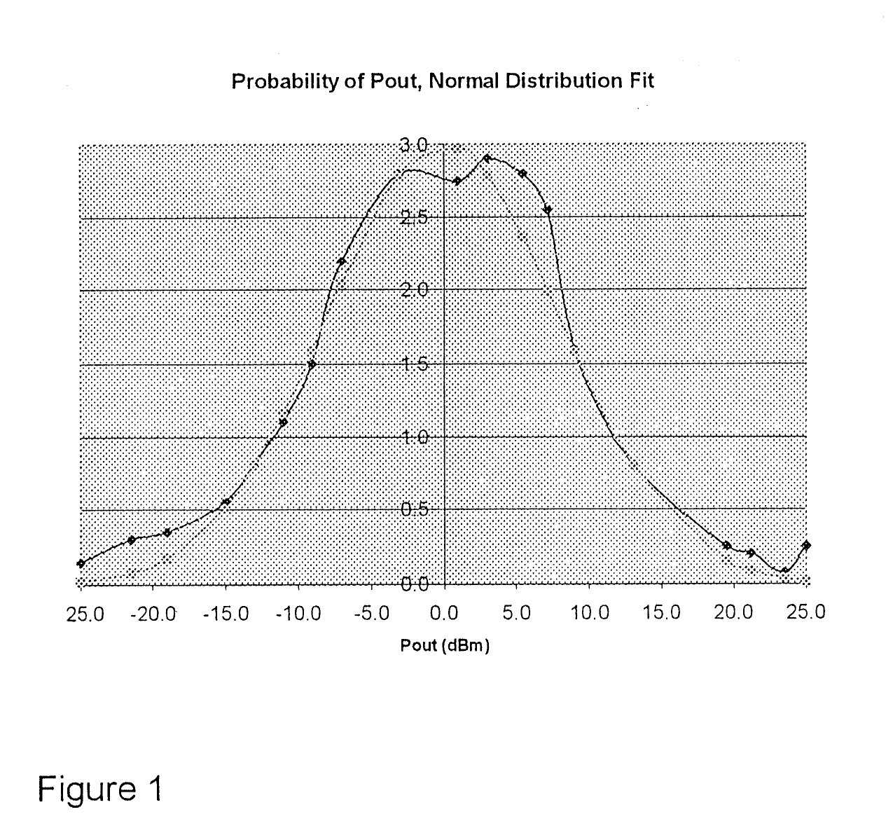

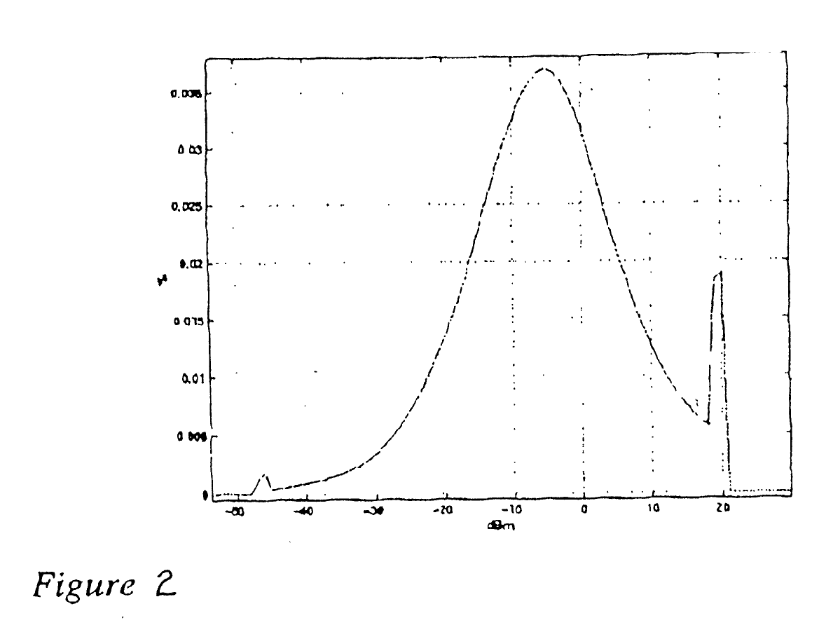

The present invention is best understood by first recapping a discussion of measured and simulated CDMA power amplifier output probability distribution with reference to FIGS. 1 and 2. As stated herein before, CDMA power amplifier output probability distributions (measured and simulated) for cellular systems show a non-Gaussian effect at maximum output power. In general, mobile station output power is proportional to the propagation loss from the mobile station to the base station. Because the mobile travels randomly through the circular cells, one would expect a Gaussian (normal) distribution of propagation loss and hence, mobile station transmitted power. FIG. 1, for example, is a graph illustrating measured probability of a given power output that is fit to a normal distribution at the measured Pout points for an IS-95 CDMA handset power amplifier. It can be seen that a 6% peak occurs at maximum output power. FIG. 2 is a graph illustrating a simulated distribution function of output power in a WCDMA system that employs a Nokia® handset power amplifier. It can be seen that a 50% peak occurs at maximum power out. These power levels are commanded by the base station and are a function of the signal to noise level measured at the base station receiver. FIGS. 1 and 2 demonstrate that at high power, the curve is not symmetrical and has a distinct peak at the highest power output where the most battery power is consumed.

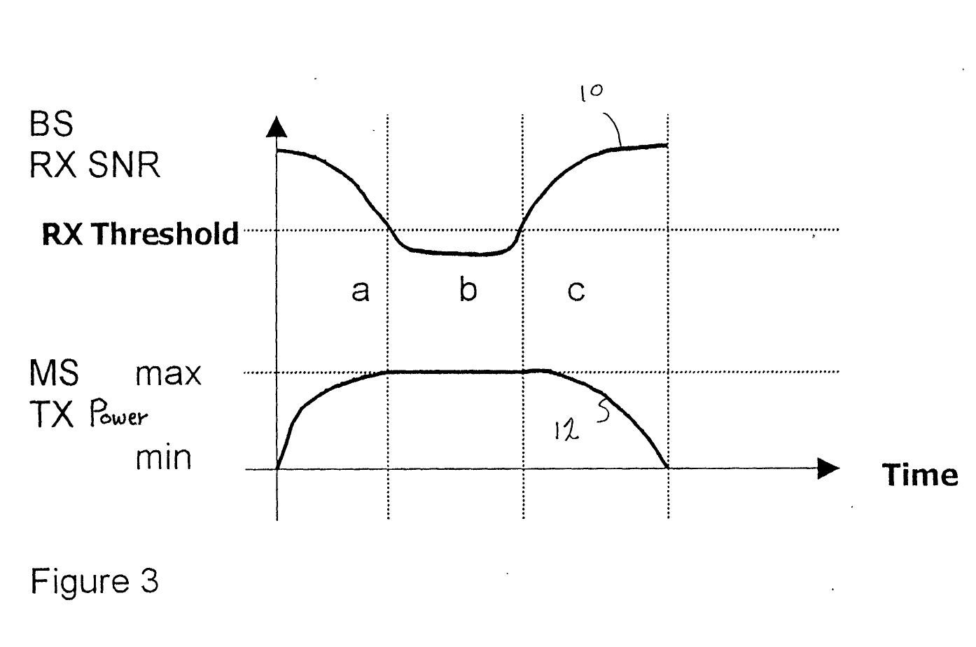

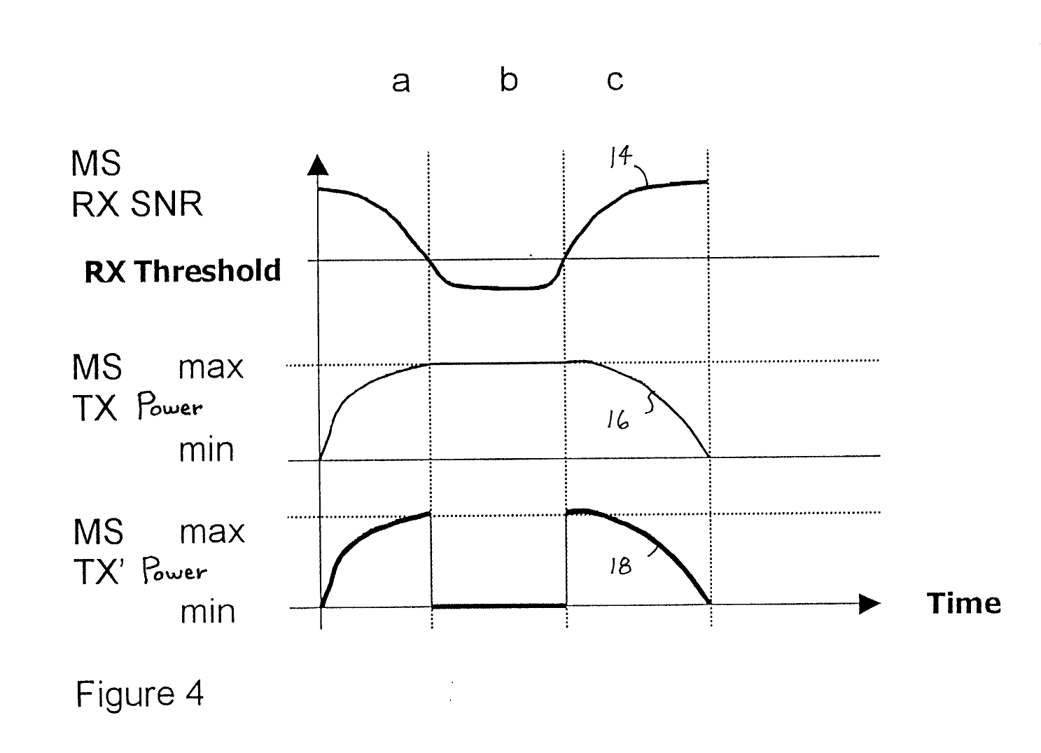

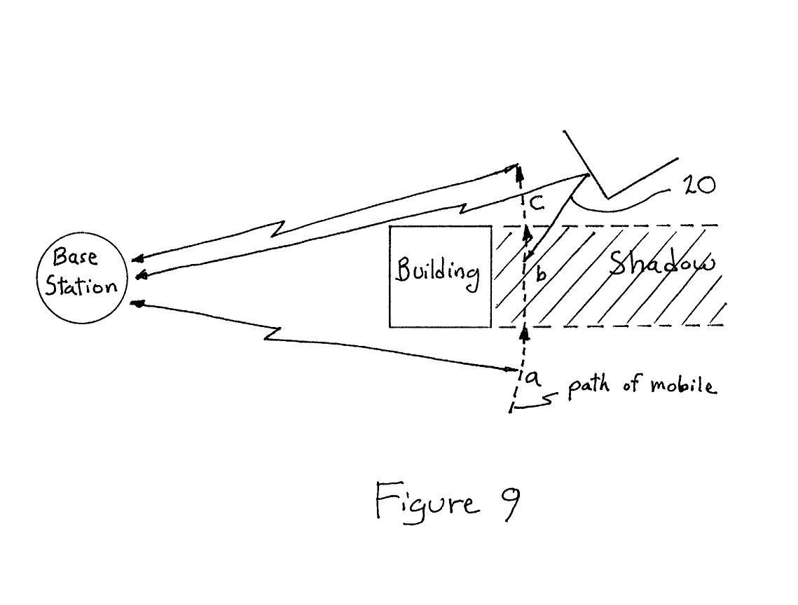

The present invention, that takes advantage of an imbalance between mobile and base station transmit power (effective radiated) levels, described herein with reference to FIGS. 3 and 4, is directed to a scheme to limit mobile transmitter output in poor propagation situations to avoid wasted RF and DC power. It can be appreciated that the base station transmitter is several orders of magnitude more powerful than the mobile station. The mobile station receive SNR therefore, would be much better (on average) than the base station SNR. FIG. 3, for example, is a graph illustrating one representation of a base station received signal to noise ratio (SNR) 10 and a mobile station transmitted power level 12. When the mobile station starts to go into a fade (i.e. when moving from point ‘a’ to point ‘b’ along path a-b-c as seen in FIG. 9), the received SNR 10 at the base station falls. The base station attempts to maintain a constant SNR by commanding the mobile station transmitter to increase its power level 12 in a constant increment (i.e. 1-dB steps according to IS-95). When the received SNR 10 at the base station is below the useable threshold (region b), communication is not possible and the mobile station is transmitting (needlessly) at its full power level 12. The base station will hold the mobile transmitter at its full power level 12 until the base station received SNR 10 improves such as seen in region c. Dwelling at full power, in this case, is the cause of the spikes seen in FIGS. 1 and 2.

In view of the foregoing, a technique to improve handset efficiency and power control according to one embodiment of the present invention is now set forth with reference to FIG. 4 that is a graph illustrating one representation of a mobile station receiver SNR 14, an original transmit power spectrum 16 associated with the mobile station transmitter and an improved transmit power spectrum 18 associated with the mobile station transmitter. In a ddition to a conventional closed loop (base station receive and mobile station transmit) power control algorithm, a knowledge of the mobile station received SNR 14 is used to disable the mobile station transmitter and prevent fruitless expenditure of battery power. When the mobile station received SNR 14 falls below a set threshold (region b in FIG. 4), there is no point in continuing to transmit from the mobile station, as the handset is in a propagation shadow and incapable of communicating with the base station. Even a reflected path 20 such seen in FIG. 9 is insufficient for communication. The mobile station receiver and computing algorithms then instruct the mobile station transmitter to enter its idle power condition until a useful receive signal is again acquired such as seen in region c of FIG. 4. When a useful receive signal is acquired such as seen in region c, the mobile station transmitter signal is ramped up to its previous power level.

The present invention is not so limited however, and it can be appreciated, for example, that the transmitter need not ramp back to an idle condition (i.e. off state), but instead to a median transmit power condition determined from a previous period of time. This power could, for example, be that which was sufficient to support the link up to fade. Such functionality can also act as a slow release AGC for the mobile station transmitter. This would be like a fast-attack/slow-release AGC on transmit power that is implemented in response to the mobile station received SNR 14 discussed herein before.

It can be appreciated there may be several methods for determining a situation where the mobile station is in a shadow of the desired base station. One method employs use of the mobile station received SNR 14 discussed above. Another method may include analyzing a loss of primary base station rake finger. Yet another method may include monitoring for an abrupt change in the delay of the received signal relative to other neighboring base stations. Any of these methods, alone or in combination, may define a shadow condition. It can be readily appreciated however, that the present invention will function in association with any technique suitable to define a shadow condition.

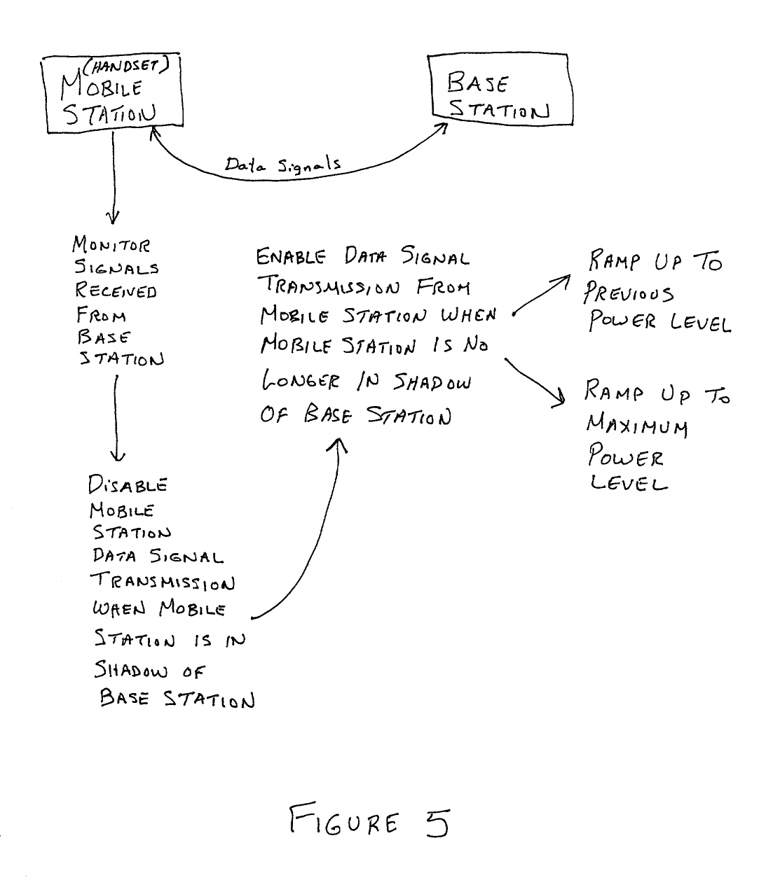

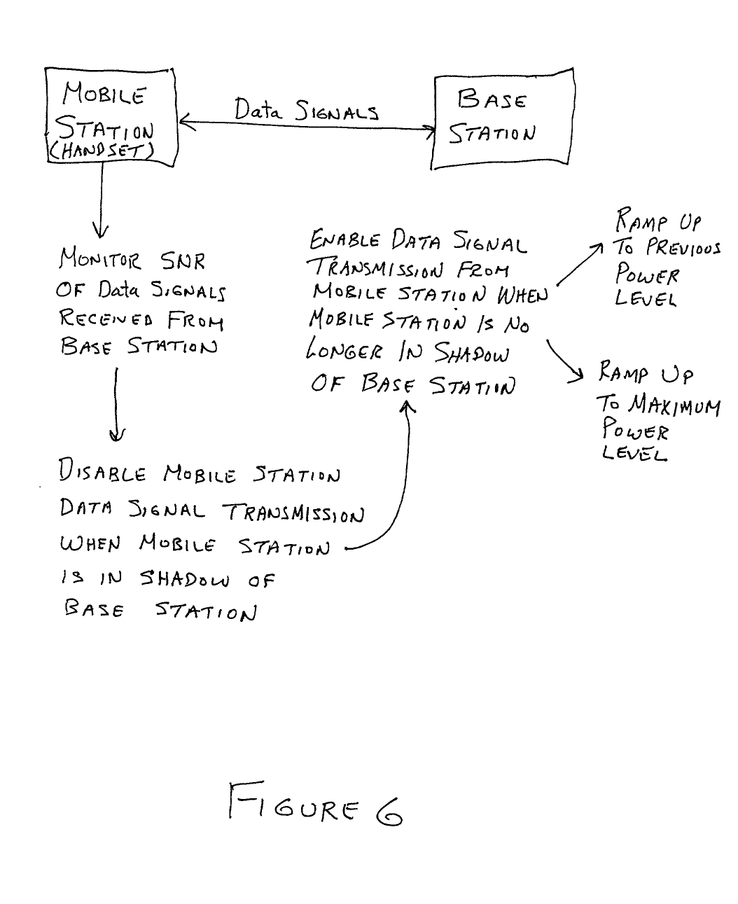

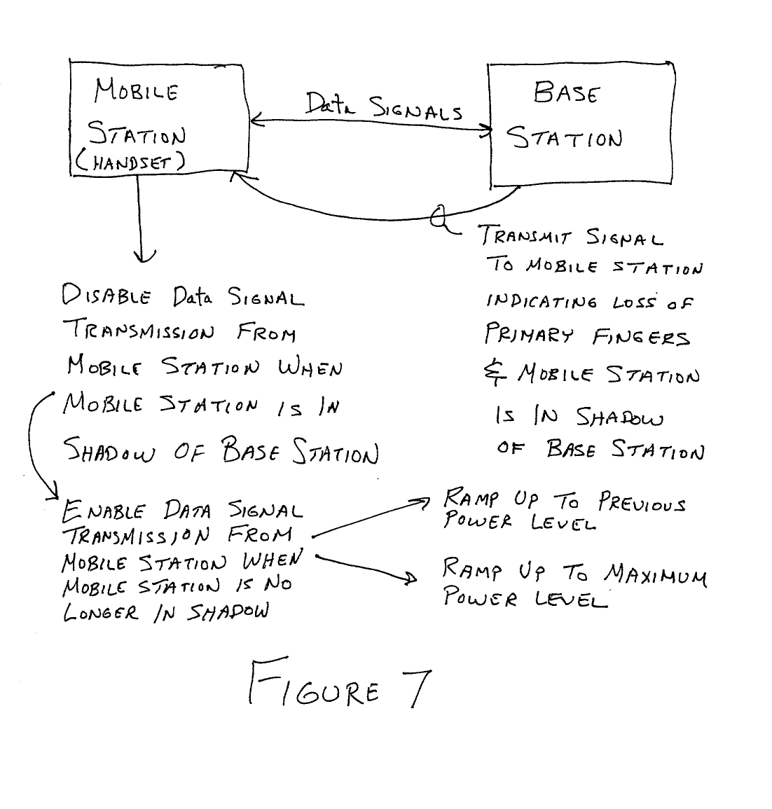

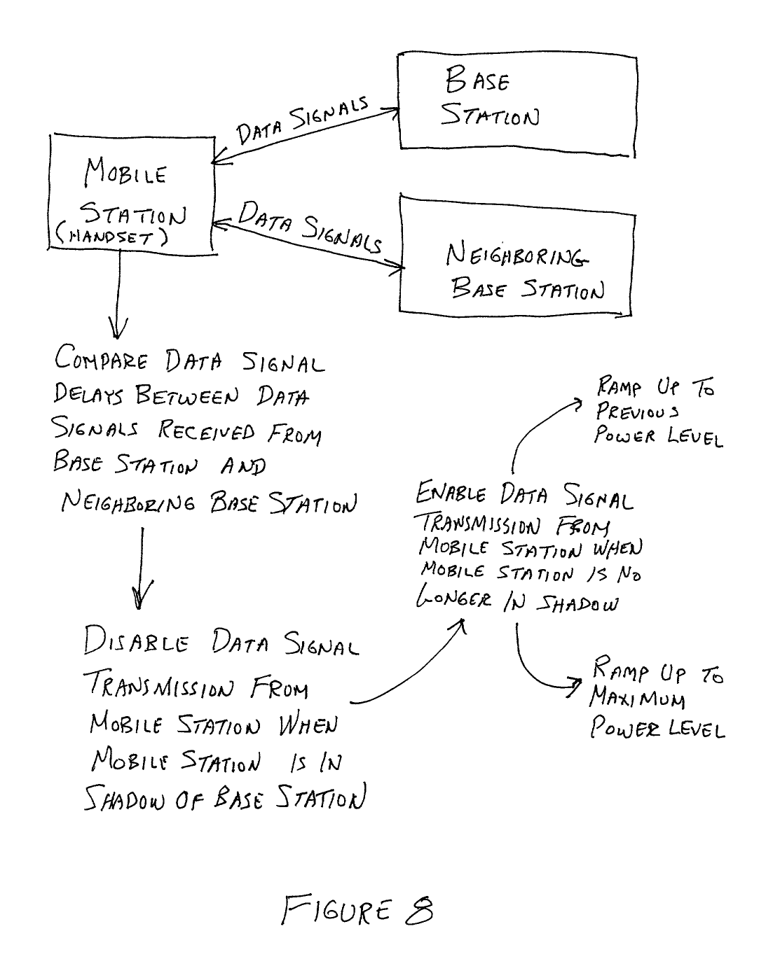

It can also be appreciated that the situation in which the mobile station is shadowed can also occur without the handset reaching full output power. In such a case, the mobile station computer will command the mobile station transmitter to enter into an idle state. When the handset is moved from behind the shadow, the mobile transmitter is again commanded by the mobile computer to invoke the previous transmit communication power. A slow release mode can be invoked as an alternative to a full shut down. In each case, the activity of ramping the mobile transmitter is generally required to fall inside a power-time specification (i.e. mask) that can be problematic since the ramping generates additional spectral noise. FIGS. 5-8 are diagrams illustrating cellular handset transceiver systems for minimal power consumption according to different embodiments of the present invention discussed herein before.

In view of the above, it can be seen that the present invention presents a significant advancement in the art of communication between a base station and a mobile station system to extend CDMA handset talk time. Further, this invention has been described in considerable detail in order to provide those skilled in the data communication art with the information needed to apply the novel principles and to construct and use such specialized components as are required. In view of the foregoing descriptions, it should be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims which follow.

What is claimed is:

1. A method of data communication between a base station and a mobile station over a wireless communication network, the method comprising the steps of:
transmitting a data signal between a mobile station and a base station;
monitoring the data signal received by the mobile station from the base station; and
disabling transmission of the data signal by the mobile station when the mobile station is in a shadow of the base station.

2. The method according to claim 1 wherein the step of monitoring the data signal received by the mobile station from the base station comprises monitoring the signal to noise ratio (SNR) of the data signal received by the mobile station from the base station to provide a determination whether the mobile station is in a shadow of the base station.

3. The method according to claim 1 wherein the step of monitoring the data signal received by the mobile station from the base station comprises receiving a signal from the base station that indicates a loss of primary base station rake fingers to provide a determination whether the mobile station is in a shadow of the base station.

4. The method according to claim 1 further comprises the steps of:
monitoring the delay of the data signal received by the mobile station from the base station; and
identifying an abrupt change in the delay received by the mobile station from the base station to provide an indication of whether the mobile station is in a shadow of the base station.

5. The method according to claim 1 wherein the step of disabling transmission of the data signal by the mobile station when the mobile station is in a shadow of the base station comprises causing a transmitter associated with the mobile station to ramp down its power output until the mobile station transmitter enters an idle (off) state.

6. The method according to claim 1 wherein the step of disabling transmission of the data signal by the mobile station when the mobile station is in a shadow of the base station comprises causing a transmitter associated with the mobile station to ramp down its power output to achieve a power condition associated with a previous period of time.

7. The method according to claim 1 further comprising the step of enabling transmission of the data signal by the mobile station when the mobile station is no longer in a shadow of the base station and subsequent to disabling transmission of the data signal at a previous power level by the mobile station.

8. The method according to claim 7 wherein the step of enabling transmission of the data signal by the mobile station subsequent to disabling transmission of the data signal by the mobile station comprises causing a transmitter associated with the mobile station to ramp up its power output until the mobile station transmitter output power level reaches a previous power level.

9. The method according to claim 7 wherein the step of enabling transmission of the data signal by the mobile station subsequent to disabling transmission of the data signal by the mobile station comprises causing a transmitter associated with the mobile station to ramp up its power output until the mobile station transmitter output power level reaches a maximum power level.

10. A method of data communication between a base station and a mobile station over a wireless communication network, the method comprising the steps of:
transmitting a data signal between a mobile station and a base station;
monitoring the signal to noise ratio (SNR) of the data signal received by the mobile station from the base station to provide a determination whether the mobile station is in a shadow of the base station; and
disabling transmission of the data signal by the mobile station when the mobile station is in a shadow of the base station.

11. The method according to claim 10 wherein the step of disabling transmission of the data signal by the mobile station when the mobile station is in a shadow of the base station comprises causing a transmitter associated with the mobile station to ramp down its power output until the mobile station transmitter enters an idle (off) state.

12. The method according to claim 10 wherein the step of disabling transmission of the data signal by the mobile station when the mobile station is in a shadow of the base station comprises causing a transmitter associated with the mobile station to ramp down its power output to achieve a power condition associated with a previous period of time.

13. The method according to claim 10 further comprising the step of enabling transmission of the data signal by the mobile station when the mobile station is no longer in a shadow of the base station and subsequent to disabling transmission of the data signal by the mobile station.

14. The method according to claim 13 wherein the step of enabling transmission of the data signal by the mobile station subsequent to disabling transmission of the data signal by the mobile station comprises causing a transmitter associated with the mobile station to ramp up its power output until the mobile station transmitter output power level reaches a previous power level.

15. The method according to claim 13 wherein the step of enabling transmission of the data signal by the mobile station subsequent to disabling transmission of the data signal by the mobile station comprises causing a transmitter associated with the mobile station to ramp up its power output until the mobile station transmitter output power level reaches a maximum power level.

16. A method of data communication between a base station and a mobile station over a wireless communication network, the method comprising the steps of:
transmitting a data signal between a mobile station and a base station;
transmitting a signal from the base station to the mobile station that indicates a loss of at least one primary base station rake finger to provide a determination whether the mobile station is in a shadow of the base station; and
disabling transmission of the data signal by the mobile station when the mobile station is in a shadow of the base station.

17. The method according to claim 16 wherein the step of disabling transmission of the data signal by the mobile station when the mobile station is in a shadow of the base station comprises causing a transmitter associated with the mobile station to ramp down its power output until the mobile station transmitter enters an idle (off) state.

18. The method according to claim 16 wherein the step of disabling transmission of the data signal by the mobile station when the mobile station is in a shadow of the base station comprises causing a transmitter associated with the mobile station to ramp down its power output to achieve a power condition associated with a previous period of time.

19. The method according to claim 16 further comprising the step of enabling transmission of the data signal by the mobile station when the mobile station is no longer in a shadow of the base station and subsequent to disabling transmission of the data signal by the mobile station.

20. The method according to claim 19 wherein the step of enabling transmission of the data signal by the mobile station subsequent to disabling transmission of the data signal by the mobile station comprises causing a transmitter associated with the mobile station to ramp up its power output until the mobile station transmitter output power level reaches a previous power level.

21. The method according to claim 19 wherein the step of enabling transmission of the data signal by the mobile station subsequent to disabling transmission of the data signal by the mobile station comprises causing a transmitter associated with the mobile station to ramp up its power output until the mobile station transmitter output power level reaches a maximum power level.

22. A method of data communication between a base station and a mobile station over a wireless communication network, the method comprising the steps of:
transmitting a data signal between a mobile station and a base station;
monitoring the data signal received by the mobile station from the base station;
detecting an abrupt change in signal delay received by the mobile station from the base station to provide an indication of whether the mobile station is in a shadow of the base station; and
disabling transmission of the data signal by the mobile station when the mobile station is in a shadow of the base station.

23. The method according to claim 22 wherein the step of disabling transmission of the data signal by the mobile station when the mobile station is in a shadow of the base station comprises causing a transmitter associated with the mobile station to ramp down its power output until the mobile station transmitter enters an idle (off) state.

24. The method according to claim 22 wherein the step of disabling transmission of the data signal by the mobile station when the mobile station is in a shadow of the base station comprises causing a transmitter associated with the mobile station to ramp down its power output to achieve a power condition associated with a previous period of time.

25. The method according to claim 22 further comprising the step of enabling transmission of the data signal by the mobile station when the mobile station is no longer in a shadow of the base station and subsequent to disabling transmission of the data signal by the mobile station.

26. The method according to claim 25 wherein the step of enabling transmission of the data signal by the mobile station subsequent to disabling transmission of the data signal by the mobile station comprises causing a transmitter associated with the mobile station to ramp up its power output until the mobile station transmitter output power level reaches a previous power level.

27. The method according to claim 25 wherein the step of enabling transmission of the data signal by the mobile station subsequent to disabling transmission of the data signal by the mobile station comprises causing a transmitter associated with the mobile station to ramp up its power output until the mobile station transmitter output power level reaches a maximum power level.
